(19) United States
(12) Patent Application Publication
(10) Pub. No.: US 2026/0329655 A1
(43) Pub. Date: Oct. 22, 2026

(54) NATURAL LANGUAGE BASED PLATFORM FOR AGENTIC AI SYSTEMS

(71) Applicant: NEC Laboratories America, Inc., Princeton, NJ (US)

(72) Inventors: Kunal Rao, Monroe, NJ (US); Giuseppe Coviello, Robbinsville, NJ (US); Srimat Chakradhar, Manalapan, NJ (US); Gennaro Mellone, Napoli (IT); Ciro DeVita, Princeton, NJ (US)

(21) Appl. No.: 19/648,440

(22) Filed: Apr. 15, 2026

Related U.S. Application Data
(60) Provisional application No. 63/790,206, filed on Apr. 17, 2025.

(51) Int. Cl. G06F 9/50

(52) U.S. Cl. CPC G06F 9/5038

(57) ABSTRACT

Systems and methods for a platform for agentic artificial intelligence (AI) systems. The agentic AI systems include converting a user input task into a plan for execution, converting user input natural language text into a machine readable task, forming a plan from the machine readable task, wherein the plan includes tools and data applied to complete the plan, and forming a flow chart for chronologically representing the plan in a machine executable format. The agentic AI systems further include executing a portion of the flow chart in a test environment, verifying accuracy of the portion of the flow chart in the test environment, the accuracy including a metric for computer performance, in response to the accuracy of the portion failing an accuracy test in the test environment, modifying the portion, and performing the flow chart in a production environment.

### RELATED APPLICATION INFORMATION

This application claims priority to U.S. Provisional Patent Application. No. 63/790,206, filed on Apr. 17, 2025, incorporated herein by reference in its entirety.

### BACKGROUND

### Technical Field

The present invention relates to a system to build workflows and more particularly applying agentic artificial intelligence (AI) systems to streamline workflow generation and execution.

### Description of the Related Art

The development of agentic AI systems leveraging large language models (LLMs) has received significant attention. Frameworks have been designed to offer modular components for constructing LLM-powered applications, facilitate the creation of collaborative agents with defined roles and memory, perform autonomous task-solving capabilities through iterative planning and execution, and enable developers to build LLM applications via multiple conversable agents, and among other capabilities. These agents can operate in various modes, employing combinations of LLMs, human inputs, and tools. Their designs simplify the implementation of complex workflows through automated agent conversations, showcasing effectiveness across domains like mathematics, coding, and decision-making.

Further, some frameworks have contributed significantly to the field with orchestrator platforms, which enable dynamic planning, agent self-assembly, and recursive self-improvement in enterprise workflows. Others have been developed to provide user-friendly environments for developing and deploying LLM-centric applications. However, these systems often lack integrated support for structured verification and explicit control over execution plans.

### SUMMARY

According to an aspect of the present invention, a method is provided for converting user input natural language text into a machine readable task, wherein the machine readable task includes semantic understanding of the user input natural language text, forming a plan from the machine readable task, wherein the plan includes tools and data applied to complete the plan, and forming a flow chart for chronologically representing the plan in a machine executable format. The method can further include executing a portion of the flow chart in a test environment, verifying accuracy of the portion of the flow chart in the test environment, the accuracy including a metric for computer performance, in response to the accuracy of the portion failing an accuracy test in the test environment, modifying the portion, and performing the flow chart in a production environment.

According to another aspect of the present invention, a system is provided for a processor and a memory storing computer-readable instructions. The computer-readable instructions, when executed by the processor, cause the processor to convert user input natural language text into a machine readable task, wherein the machine readable task includes semantic understanding of the user input natural language text, form a plan from the machine readable task, wherein the plan includes tools and data applied to complete the plan, and form a flow chart for chronologically representing the plan in a machine executable format. The computer-readable instruction can also cause the processor to execute a portion of the flow chart in a test environment, verify accuracy of the portion of the flow chart in the test environment, the accuracy including a metric for computer performance, in response to the accuracy of the portion failing an accuracy test in the test environment, modify the portion, and perform the flow chart in a production environment.

According to yet another aspect of the present invention, a computer program product including a non-transitory computer-readable storage medium containing computer program code is provided. The computer program product, when executed, causes the one or more processors to convert user input natural language text into a machine readable task, wherein the machine readable task includes semantic understanding of the user input natural language text, form a plan from the machine readable task, wherein the plan includes tools and data applied to complete the plan, form a flow chart for chronologically representing the plan in a machine executable format, and execute a portion of the flow chart in a test environment. The computer program product further causes the one or more processors to verify accuracy of the portion of the flow chart in the test environment, the accuracy including a metric for computer performance, in response to the accuracy of the portion failing an accuracy test in the test environment, modify the portion, and perform the flow chart in a production environment.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for generating execution plans from natural language, in accordance with an embodiment of the present invention;

FIG. 2 is a plan illustrating an intermediary output of the system, in accordance with an embodiment of the present invention;

FIG. 3 is a flow chart illustrating a plan with opportunities for parallel computing, in accordance with an embodiment of the present invention;

FIGS. 4 and 5 are texts prompts that can be input into the agentic AI system to form the plan, in accordance with an embodiment of the present invention;

FIG. 6 is a block diagram illustrating a high-level system for generating execution plans from natural language, in accordance with an embodiment of the present invention;

FIG. 7 is a block diagram of an agentic AI system with an exemplary input and output, in accordance with an embodiment of the present invention;

FIG. 8 is a flow diagram illustrating a method of generating and performing a plan with the agentic AI system, in accordance with an embodiment of the present invention; and

FIG. 9 is a block diagram illustrating a computing environment for executing the agentic AI system, in accordance with an embodiment of the present invention.

### DETAILED DESCRIPTION OF PREFERRED EMBODIMENTS

Embodiments of the present invention provide a pipeline framework that performs plan generation and flow graph compilation from the plan. The plan is then executed and verified. The process can intermittently include human feedback of the plan to ensure accuracy, among other things. The framework can include several components such as e.g., a planner, a compiler, an executor, and a verifier.

The planner can leverage (e.g., prompt) a Large Language Model (LLM) to generate a plan using natural language, machine language, visual data, sound data, etc., or some combination thereof. In these alternative embodiments of the present invention, a multi-modal LLM (MLLM) can be employed. The plan can be considered a structured step-by-step business workflow to accomplish certain goals. The compiler can leverage either the same or a different LLM to compile the plan into a flow graph for execution. The executor can leverage the LLM to reason through, and execute steps within the flow graph through, a run time on an underlying cluster. The verifier can leverage an LLM to verify output from particular steps (intermediate or final) and provide feedback for self-correction. The LLMs employed can be the same or different or some combination thereof for each component.

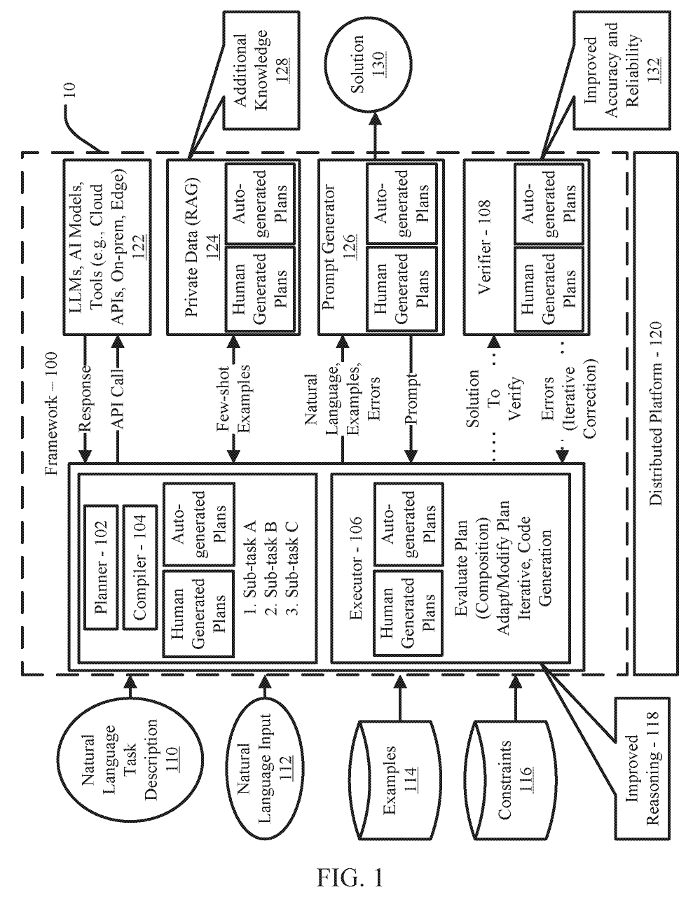

Referring now in detail to the figures in which like numerals represent the same or similar elements and initially to FIG. 1, a high-level block diagram for a natural language based platform for agentic AI systems (framework 100) is illustrated, in accordance with an embodiment of the present invention.

Agentic artificial intelligence (AI) agent 10 represents built-in components of framework 100 used to generate and execute a plan. Additional components can also be incorporated or called to aid agentic AI agent 10. An input to framework 100 can be task description 110 or natural language input 112, or both. Task description 110 can include information describing the function of the AI agent. Natural language input 112 can include information input into the AI agent. In some embodiments of the present invention, natural language input 112 can be a specific, executable task that is a type of task described in task description 110.

Task description 110 or natural language input 112 can also be machine language, code, or other types of inputs, in some embodiments of the present invention. Planner 102 can receive task description 110 and natural language input 112 and convert the input into a machine language, if the input is not in machine language as an input. The machine language in planner 102 can interpret task description 110 or natural language input 112 to include a semantic understanding of the text, but in a form that the machine can interact with more easily than interacting with an intermediary LLM. The semantic understanding can apply natural language processing (NLP) to text for the machine to apply and comprehend meaning, context, and intent to the natural language text.

The output of framework 100 can be solution 130. In some embodiments of the present invention, each task description 110 and natural language input 112 can result in a unique solution 130. In other words, solution 130 can be an injective function and/or a bijective function. Solution 130 can be the execution of a function on a system, control a physical or software system, creation of a document or some other type of data format, e.g., images, sound, videos, etc.

Generated solution 130 can be derived using available examples 114 and restricting the execution as per provided constraints 116. Provided constraints 116 can be user defined or be in compliance with industry standards, organizational norms, laws/regulations/rules/ordinances, physical, economic, temporal, or other constraints. Provided constraints 116 can be “rules” that are evaluated on the output of each step. For example, one constraint in the domain for recipes can be “when using fruits it must be in season”. Constraints are checked and enforced in a loop rather than being enforced in the initial generation.

Available examples 114 can be few-show or one-shot examples (e.g., a successful output and the corresponding input). The few-shot plans can be successful plans from previous analogous projects. Other types of examples are also contemplated. Available examples 114 and provided constraints 116 can be user defined limitations.

In some embodiments of the present invention, examples 114 can be encoded (e.g., embedded) in a vector space so that comparison of the relevance to task description 110 and natural language input 112 is facilitated. Other types of encodings are also contemplated. Task description 110 and natural language input 112 can also be encoded. For example, an image can be embedded as an example for application for a text task. Comparison of vectors can employ cosine similarity, Euclidean distance, dot product, etc.

Within framework 100, planner 102 can generate a step-by-step plan in order to accomplish the task. Then, compiler 104 can translate the plan into a flow graph which can be executed by executor 106 in both performance and testing environments. The plan executed by executor 106 can be verified by verifier 108, which verifies the output from any step within the plan in the testing environment prior to deployment in a performance environment. Verifier 108 can also work in the performance environment in some embodiments of the present invention.

To aid planner 102, compiler 104, executor 106, and verifier 108, peripheral components 122 can be incorporated into framework 100. Peripheral components 122 which can either be incorporated into, or outside of AI agent 10, can include LLMs, AI models, tools, Retrieval Augmented Generation (RAG) capability, vector databases, embedding models, knowledge graphs, workflow orchestration engines, prompt management systems / prompt generation, fine-tuning pipelines, monitoring & observability tools, caching layers, Application Programming Interfaces (API) gateways, data labeling tools, synthetic data generators, experiment tracking systems, model versioning systems, feature stores, continuous integration (CI) / continuous deployment (CD) pipelines for machine learning (ML), A/B testing platforms, human-in-the-loop review systems, feedback collection systems, access control / policy engines, latency optimization layers, load balancing systems, edge deployment frameworks, containerization platforms (e.g., Docker), cloud infrastructure platforms (e.g., Amazon Web Services, Microsoft Azure, Google Cloud), etc.

The agent developed using framework 100 can run on top of distributed platform 120 (e.g., on Kubernetes™). Peripheral components 122 can be invoked with an API call and send back a response.

Planner 102 can generate the plan corresponding to task description 110. The initial plan is generated by using an LLM using NLP techniques to translate the semantic meaning of task description 110 or natural language input 112. In some embodiments of the present invention, the plan can be edited/refined/modified/etc. by a user to specify details of the task to the LLM. The user can provide missed context, additional details, requirements, personal preferences, etc.

The tasks for solution 130 to achieve can include document generation, communicating with users or other machines, researching and retrieving information, analyzing and processing data, updating documents and processing information, such as, e.g., invoices received, managing and monitoring systems, executing code, scheduling events for users and computer execution, and controlling systems and robots.

There can be improved reasoning 118 and improved accuracy and reliability 132 by including verifier 108 to executor 106, which prevents framework 100 from several of the known issues with artificial intelligence models such as, e.g., overfitting and hallucinations. Verifier 108 can prevent these issues by automatically checking executor 106 for any number of metrics or tests. New knowledge 128 can come from private data 124 or the user to provide information that improves the output (solution 130) of framework 100. Improved reasoning 118, new knowledge 128, and reliability 132 improve the output of framework 100 for example by avoiding known classes of mistakes. The mistakes can be avoided by employing private data 124.

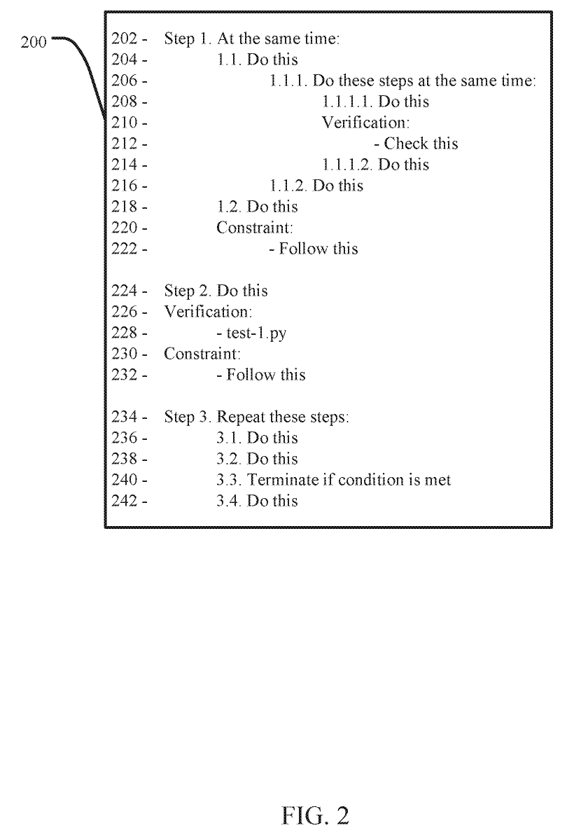

Referring to FIG. 2, pseudocode 200 of a plan generated from framework 100 is illustrated, according to an embodiment of the present invention. Pseudocode 200 includes numbered steps 202-242 representing aspects of a plan and within each step, there can be sub-steps with sub-numbering. The plan can have parallelism and looping to improve computation efficiency/runtime/etc., for example, step 202 can have some parallelism. To express parallelism, natural language can be used e.g. “At the same time” or “Do together,” etc. For instance, step 204 and step 218 can have the opportunity and possibility of being performed concurrently/in parallel, as can step 208 and step 214, and step 206 and step 216, though all steps can also be performed in series. Pseudocode 200 can be declarative agent-oriented programming language written in natural language.

In some embodiments of the present invention, if certain steps need to be repeated, a loop can be employed, such as, e.g., step 234, step 236, step 238, step 240, and step 242. This can be expressed with natural language such as e.g., “Repeat the below steps” or “Repeat these steps,” etc. To exit the loop upon meeting certain conditions, expressions such as, e.g., “Terminate,” “Stop,” etc. can be employed.

In addition, keywords such as, e.g., “Verification” and “Constraints” that can be given at any step or sub-step. Constraints (steps) 220, 230 in pseudocode 200 can be exemplify provided constraints 116 (FIG. 1). Details of constraint 220 and constraint 230 can be in step 222 and step 232. “Verification” can include one or more verification (steps) 210, 226 tests to be performed at any specific step or sub-step. Details of verification 210 and verification 226 can be in step 212 and step 228.

Tests can be written in natural language, for example sub-step 208 can be a verification step or the name of a file containing a test program can also be provided. The file can be for computer code, such as, e.g., in Python™, to verify the other steps in the plan. Step 224 in the plan can demonstrate the use of a verification file. The verification can output a Boolean value, where “true” indicates the verification test passes and “false” indicates the verification test fails.

One or more “constraints” can also be included and can be given in natural language. This can be illustrated in sub-step 218 and step 224. The constraints can be computational/complexity constraints (such as, e.g., number of tokens used; O(n)), parameters on the data (such as, e.g., only process data of people ages > 17 years old), hardware constraints, business logic constraints (such as e.g., real-world requirements), cybersecurity / data security constraints, etc.

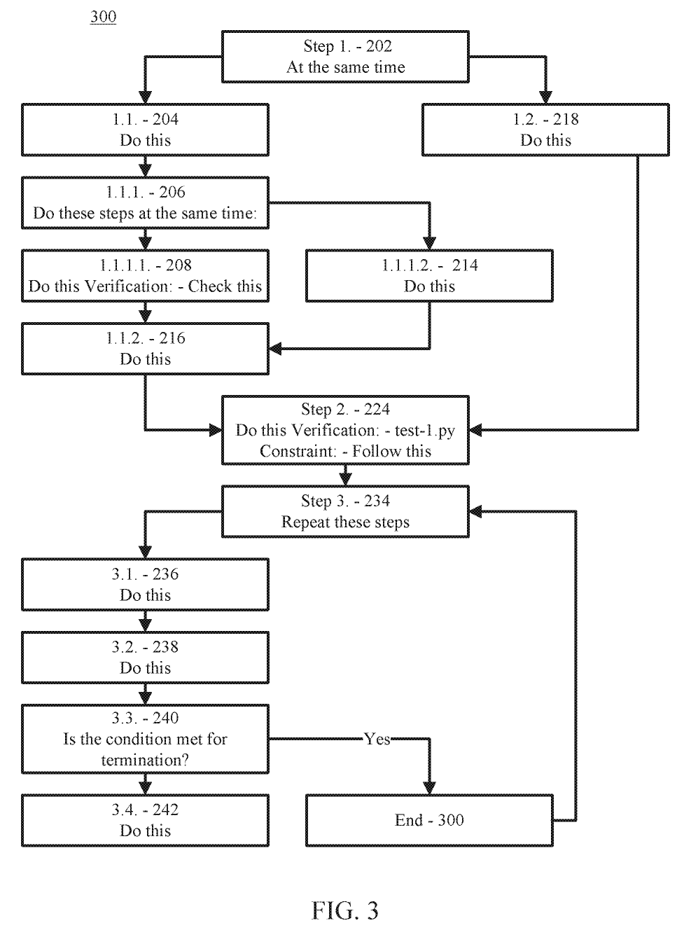

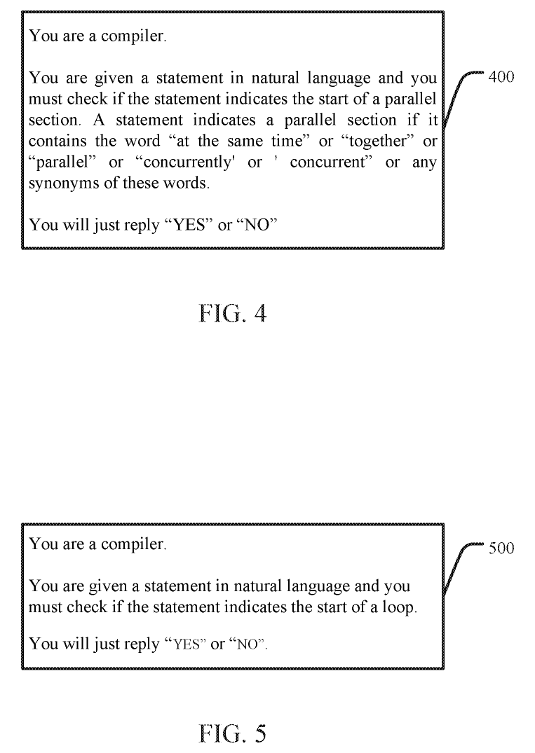

Referring to FIGS. 3, 4 and 5, compiler 104 can take the output from planner 102 and in multiple passes, compile the plan into flow graph 300 as illustrated in FIG. 3, in accordance with an embodiment of the present invention. Prompt 400 and prompt 500 can be prompts applied when forming flow graph 300.

Flow graph 300 can include the steps and sub-steps from FIG. 2. In other words, compiler 104 can translate the plan into executable steps/an execution strategy. Flow graph 300 can be stored in JSON™ format. Alternative formats are also contemplated such as, e.g. YAML™, Extensible Markup Language (XML™), Tom’s Obvious, Minimal Language (TOML™), INI, MessagePack™, Apache Avro™, Binary JSON (BSON™), Concise Binary Objection Representation (CBOR™), HashiCorp Configuration Language (HCL™), Common-Separated Values (CSV™), GraphQL™, etc. Flow graph 300 can capture the intent from the plan including parallelism, looping, termination, any verification or constraints, etc.

Flow graph 300 can also be known as a flow chart. The flow graph can show a chronological order of the plan; however, it is contemplated that other chronological orders are possible and implemented, and that several portions of flow graph 300 can change positions relative to one another. The user can actively rearrange the order of flow graph 300.

Sub-step 204 and sub-step 218 can occur in parallel. Within sub-step 204, there can be another parallel execution of sub-step 208 and sub-step 214. There can also be a loop within step 234, and the loop is exited when the termination condition in sub-step 240 is met. The parallelism and repetition constructs can be specified in natural language, and then compiler 104 (FIG. 1) can leverage an LLM to identify the constructs automatically.

For parallelism detection, compiler 104 uses prompt 400 and for loop detection, compiler 104 uses prompt 500. While doing the passes through the plan, compiler 104 identifies the steps as nodes and any sub-steps as children and creates separate nodes to spawn parallelism and proceeds to the next step only when parallel section is processed. Also, compiler 104 sets up the loop appropriately with the termination condition being triggered from the appropriate node. Flow graph 300 produced by compiler 104 (FIG. 1) is then used by executor 106 (FIG. 1) to execute the plan.

Referring back to FIG. 1, executor 106 can execute the various steps of the plan. Executor 106 can be built using third-party solutions such as, e.g., LangChain™, or proprietary solutions. The execution can be triggered whenever an input is given and explicit request to execute is provided by the user. In other embodiments of the present invention, the execution can be automatic.

Once the execution is requested, before actually beginning to execute the plan, executor 106 can dynamically load all the available tools along with their descriptions (e.g. documentation), and then push available examples 114, any associated provided constraints 116, additional files, verification programs, etc., to an LLM and RAG system, as appropriate. These peripheral components 122, files, programs, etc., prepare executor 106 by adding context of the plan. Once completed, executor 106 starts traversing flow graph 300 and executing the steps as per the flow. At each step, executor 106 executes the step (e.g., completes a task) via either directly, asking the LLM, using one of the available tools, or leveraging private data 124 (RAG), or combinations thereof. Private data 124 can communicate with planner 102, compiler 104, and executor 106, with few-shot examples. One-shot and other variations are also contemplated. Private data 124 can apply re-ranking, metadata filtering, keyword match, and other techniques to identify relevant or otherwise pertinent information in private data 124. Fine-tuning, parameter efficient fine-tuning, such as, e.g., low-rank adapters (LoRA), can also be implemented along with, or in lieu of, RAG. While traversing flow graph 300, if executor 106 encounters any parallel sections, then executor 106 can run the parallel sections in separate threads and join the threads with entire conversation history and continue execution in the main process.

The reasoning module within executor 106 finds the appropriate method to execute the step. If there are any verification steps, executor 106 invokes verifier 108 to check if the generated output passes the test or not (e.g., passes or fails). Verifier 108 can determine the amount of information sufficient for the LLM to accomplish the task in task description 110. In some embodiments of the present invention, verifier 108 can provide additional feedback in addition to a Boolean value. For example, verifier 108 can include what in particular fails, how much the step failed by, which constraint, rule, or threshold was violated, an expected versus actual result comparison, a quantified deviation score (e.g., magnitude of error, confidence delta, constraint violation amount), one or more evaluation metric values (such as accuracy, similarity score, loss value, or policy compliance score), a classification of the error type, a severity level, token-level or feature-level attribution identifying a source of the failure, trace identifiers for debugging, timestamps corresponding to execution, metadata indicating the model version, tool instance, or configuration involved, whether the failure is deterministic or stochastic, a confidence score for the verification result itself, historical comparison data from prior executions, and a recommended corrective action, retry strategy, etc. In some embodiments of the present invention, verifier 108 can fail flow graph 300 for not being efficient (enough), rather than for complete failure to perform the task. In other words, too high of a runtime or latency can be a reason for verifier 108 to fail the plan.

Framework 100 can have several environments to perform the plan in. An environment that can perform the plan is a testing environment which can act as a sandbox, or otherwise not for actual use. Another environment can be a production environment, which performs the plan once verifier 108 determines that the plan is complete, accurate, satisfactory, etc. The production environment can be the same as, or different from, the testing environment in a variety of aspects. The testing environment can skip retrieving information and calling tools, to save time and resources, in some embodiments of the present inventions, such as, e.g., when the task is document generation.

Framework 100, can be measured by investigating planning overhead, tool invocation overhead, number of repeated reasoning loops, number of repeated self-correction retries, over-decomposition of tasks, number of repeated tokens used, number of repeated tokens per successful task, cost per solution, number of thoughts, number of tool calls, number of retries, depth of plan tree, number of repeated tool calls per task, number of repeated redundant tool invocations, number of repeated failed tool calls, latency per tool, number of repeated error recovery loops, number of repeated self-correction actions, number of repeated code fails and retries, time from input to output, number of branches, number of decision paths, number of duplicate functions, number of duplicate loops, number of recomputed values, etc. Optimizing for one or more of these criteria can ensure that framework 100 is performing the task as intended.

If the test in verifier 108 does not pass, then executor 106 repeats the step with some error feedback taken into account. Prompt generator 126 can be invoked to revise the prompt based on feedback from verifier 108. Prompt generator 126 can communicate with planner 102, compiler 104, and executor 106 by providing natural language, examples, and errors to the components, and receiving prompts. When repeating a step inside executor 106 / verifier 108, the error in one or more of the previous runs can be provided to the LLM and instructed to avoid, either explicitly, implicitly, or inherently. In other words, there can be iterative learning such as reinforcement learning in framework 100.

Executor 106 can send solution 130 to verify and verifier 108 sends errors (if any exist) to have iterative correction. Prompt generator 126 can generate additional information in the form of a prompt to identify the error and prevent the error from occurring again. The prompt can be input into planner 102 and compiler 104 as well as executor 106, in executor 106 while bypassing planner 102 and compiler 104.

With this repetition, executor 106 iteratively “corrects” the output, which leads to better (improved) accuracy and reliability 132. Once the execution process reaches the last step, executor 106 can wait for the next input and repeat the steps all for the next input.

The plan can have one or more verification tests for any step or sub-step. These verification tests can be performed by verifier 108 upon invocation by executor 106. Whenever verifier 108 receives any verification request, prior to verifying, verifier 108 checks if the input is a verification program or a natural language description 110. If it is a verification program, then the verifier executes the program with the output from the step (or sub-step) as the input to the program. The response from the program is expected to be a Boolean value (true for pass, and false for fail). This Boolean value response is then sent back to executor 106.

An alternative embodiment of the present invention can have verifier 108 can verify a prompt such as, e.g., “run the script filename.py” and if the script returns “True” then the verification passes, otherwise the verification fails. An explanation can be provided if the verification fails.

If the received verification request is written in natural language, then verifier 108 leverages LLM to generate a set of “yes/no” questions. Then, verifier 108 can use an LLM to check if the output from the step passes the “yes/no” test questions, which are automatically generated using the LLM. The response to these questions is sent back to executor 106. With all these components e.g., planner 102, compiler 104, executor 106, and verifier 108, framework 100 ensures that the output provided by the “agent” is more accurate and reliable.

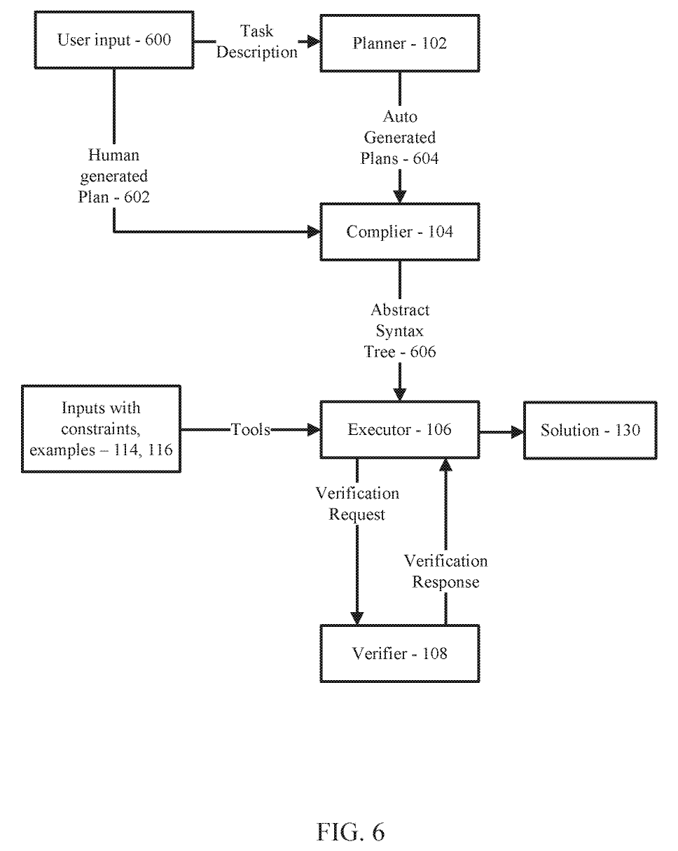

Referring to FIG. 6, block diagram of framework 100 is illustrated, according to an embodiment of the present invention. Several of the components are the same as those described in FIG. 1 and will not be described for the sake of clarity and brevity. Abstract syntax tree 606 can represent the same information as flow graph 300 (FIG. 3). Abstract syntax tree 606 can be formed by compiler 104 based on human generated plans 602 or autogenerated plans 604, or combinations thereof. Human generated plans 602 and autogenerated plans 604 can be fed into other components also seen in FIG. 1 such as, e.g., planner 102, executor 106, verifier 108, peripheral components 122, private data 124, and prompt generator 126.

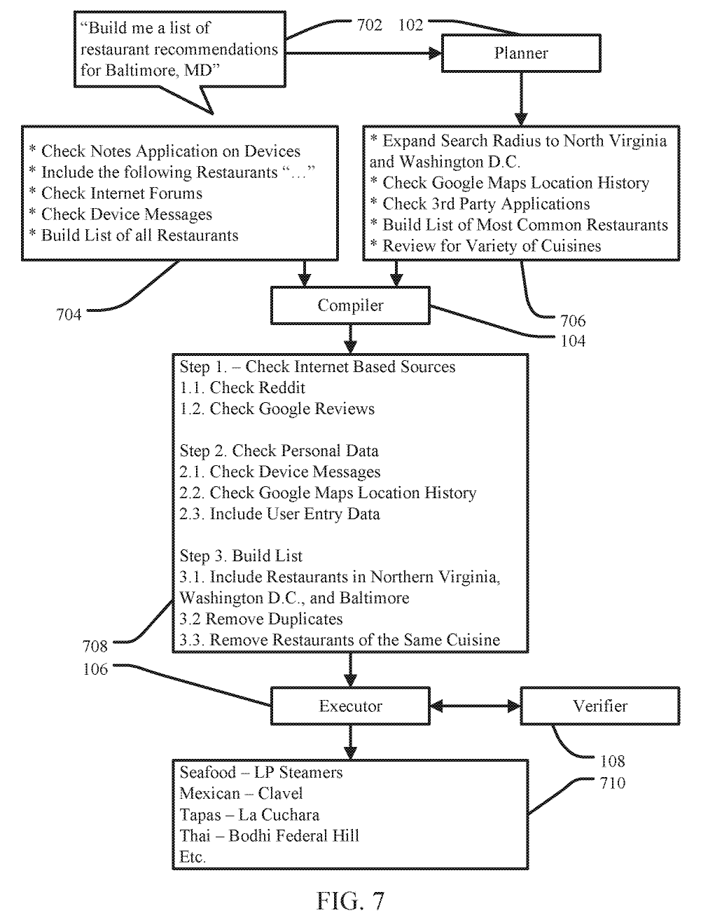

Referring to FIG. 7, a block diagram implementing framework 100 is illustrated, according to embodiments of the present invention. In text description 702 a task can be input in natural language form. The natural language can be e.g., English text input, though in other embodiments of the present invention, sound, visual, code, etc. can be input instead of natural language text. Text description 702 can include the prompt “build me a list of restaurant recommendations for Baltimore, MD.” Text description 702 can also be multi-modal.

Text description 702 can be input into planner 102 which can generate planner plan 706. Planner plan 706 can include calls to tools and information that is privately held, e.g., not publicly accessible. The non-public information can be in a RAG database or from files accessible by planner 102 or input by a user. Along with planner plan 706 can be user plan 704. User plan 704 can be a user attempt at generating a plan for the goal encompassed in text description 702. Several of the aspects of user plan 704 and planner plan 706 can be the same or different. The plans can be combined/augmented/etc. in compiler 104 to form flow graph 708. Several of the aspects from user plan 704 and planner plan 706 can be combined to build flow graph 708. For example, “check device messages” can sift through messages for recommendations on restaurants discussed, whereas planner plan 706 did not contemplate this. By combining user plan 704 and planner plan 706, flow graph 708 includes this type of information for recommending restaurants.

Planner 102 and compiler 104 can adaptively learn from information and types of information in user plan 704 for future plans. In other words, the information can be stored in the RAG database, and the type of tools can be remembered for future use.

The user can review and modify flow graph 708. Once flow graph 708 is complete, executor 106 can execute flow graph 708 along with verifier 108. Output 710 can be the result, which can be the performance of a task, creation of a document, etc.

Alternative embodiments of the present invention can be used in other in other industries and for other purposes. For example, in healthcare, documents and reports can be drafted from prompting framework 100 (FIG. 1). A healthcare professional can prompt an LLM to generate checkup notes, a surgery report, etc. The report can initially have errors from the LLM in the plan and flow graph 300 (FIG. 3) (e.g., hallucinations, etc.), which can be identified and removed using executor 106 and verifier 108. For example, the date of creation of the document can be inaccurate, or the actual drug or vaccine administered or prescribed and be inaccurate. A complete, accurate, and comprehensive document can be formed through one or more iterations of framework 100 based on planner 102, compiler 104, executor 106, and verifier 108 refining the document. Additionally, executor 106 can act based on the document, such as, e.g., informing a receptionist that additional follow-up visits are necessary and prompt the scheduling of the visit, or create a reminder, or other tasks.

Other contemplated embodiments of the present invention can include diagnosis of home or auto repairs. Text description 702 can include a description of the problem identified by the user. Text description 702 can be either, or both of, task description 110 and natural language input 112 based on the sophistication of the user and the level of detail of their prompt. Planner 102 can go through several iterations of conversational replies in text description 702 to form planner plan 706. Once a plan is drafted, in some embodiments of the present invention, the plan can be refined, either by having the user provide a supplemental draft, directly modifying planner plan 706, or prompting planner 102 to modify planner plan 706. For example, inputting into an LLM that “a sink is leaking” or something more descriptive or technically detailed like “my 2022 Honda CRV LX is making a sound like metal is scratching when I brake, the sound is coming from the rear right wheel” can be used generate a plan. Private data 124 (FIG. 1) or constraints 116 (FIG. 1) can be used to help with the plan. Private data 124 can include the sink model or previous service history of the vehicle. Constraints 116 can include cost constraints, time constraints, geographic constraints, etc. Compiler 104 can generate flow graph 708 based on user plan 704, planner plan 706, private data 124, and provided constraints 116. Executor 106 and verifier 108 can order parts, place items into Internet based website “shopping carts” affiliated with stores selling the parts identified to solve the problem, schedule diagnostic visits with plumbers or mechanics, etc. Verifier 108 can ensure the parts are available on the website, the autobody shop is open for the day and still in business, etc.

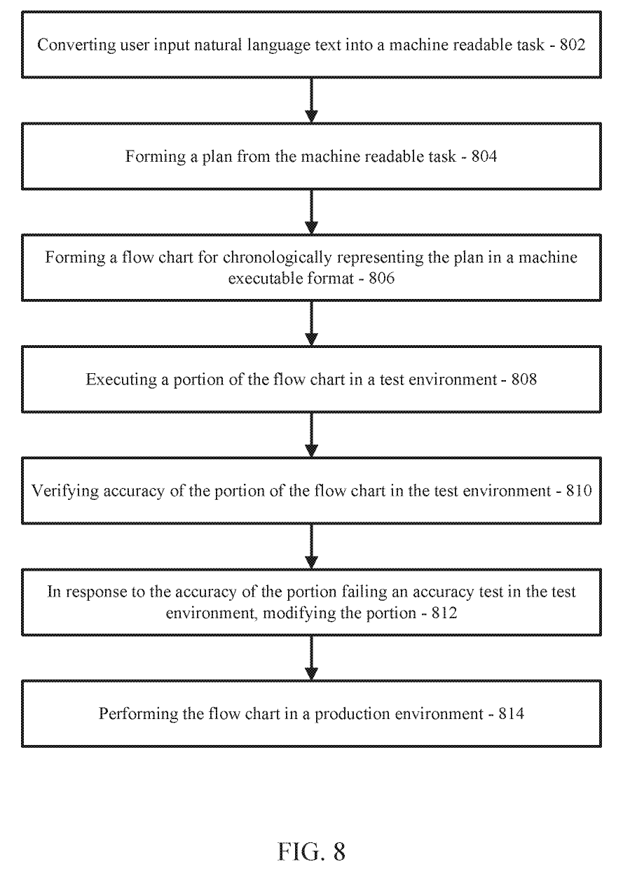

Referring to FIG. 8, a method of performing framework 100 is illustratively depicted. One or more of the steps can be optional embodiments of the present invention and any number of combinations can be incorporated together. In block 802, user input natural language text is converted into a machine readable task, wherein the machine readable task includes semantic understanding of the user input natural language text. In block 804, a plan is formed from the machine readable task, wherein the plan includes tools and data applied to complete the plan. In block 806, a flow chart is formed for chronologically representing the plan in a machine executable format. In block 808, a portion of the flow chart is executed in a test environment. In block 810, accuracy of the portion of the flow chart is verified in the test environment, the accuracy including a metric for computer performance. In block 812, in response to the accuracy of the portion failing an accuracy test in the test environment, the portion is modified. In block 814, the flow chart is performed in a production environment.

Optional additional embodiments of the present invention can also be included. Any number of optional embodiments of the present invention can be combined. A prompt can be generated to document or record a verified inaccurate portion from the test environment. The additional prompt prevents the framework from repeating the same reason for failing the accuracy test and incorporates the prompt into the flow chart. Constraints can be incorporated into the plan and flow chart, these constraints can be user defined or governed from pre-programmed standards. Few-shot examples can be provided when forming the machine readable plan or machine readable flow chart. External tools can be invoked to perform portions of the plan and flow chart. The external tools can be APIs. External private data such as a RAG can be implemented into the plan. Alternatives to RAG databases are contemplated as well. The forming of the flow chart can identify opportunities for parallel computing and generate parallel portions in the flow chart for execution in the production environment.

Other optional embodiments of the present invention can include identifying and generating flow chart portions that reflect and incorporate parallel or concurrent computing. Other embodiments of the present invention can otherwise improve computing, such as rearranging portions of the flow chart to remove bottlenecks, backlogs, improve memory utilization and computing resource utilization, etc. The flow chart can be verified for accuracy. Accuracy can be optimization of the execution, such as, e.g., improved computing resource utilization or computing performance, accuracy of the response, or other criteria for judging the plan, like balancing runtime with loss.

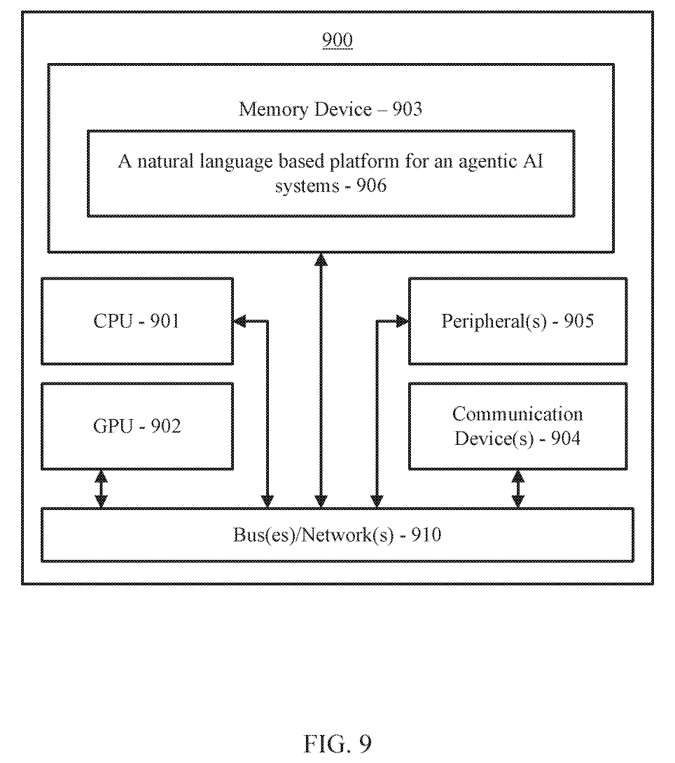

Referring to FIG. 9, a block diagram is shown for an exemplary processing system 900, in accordance with an embodiment of the present invention. The processing system 900 includes a set of processing units (e.g., CPUs) 901, a set of GPUs 902, a set of memory devices 903, a set of communication devices 904, and a set of peripherals 905. The CPUs 901 can be single or multi-core CPUs. The GPUs 902 can be single or multi-core GPUs. The one or more memory devices 903 can include caches, RAMs, ROMs, and other memories (flash, optical, magnetic, etc.). The communication devices 904 can include wireless and/or wired communication devices (e.g., network (e.g., Wi-Fi®, etc.) adapters, etc.). The peripherals 905 can include a display device, a user input device, a printer, an imaging device, and so forth. Elements of processing system 900 are connected by one or more buses or networks (collectively denoted by the figure reference numeral 910).

In an embodiment of the present invention, memory devices 903 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 903 store program code or software 906 for a natural language based platform for an agentic AI system. The software 906 implements one or more functions of the systems and methods described herein for converting user input natural language text into a machine readable task, wherein the machine readable task includes semantic understanding of the user input natural language text, forming a plan from the machine readable task, wherein the plan includes tools and data applied to complete the plan, forming a flow chart for chronologically representing the plan in a machine executable format, and executing a portion of the flow chart in a test environment. Software 906 also includes verifying accuracy of the portion of the flow chart in the test environment, the accuracy including a metric for computer performance, in response to the accuracy of the portion failing an accuracy test in the test environment, modifying the portion, and performing the flow chart in a production environment.

Of course, the processing system 900 may also include other elements (not shown), as readily contemplated by one of skill in the art, as well as omitting certain elements. For example, various other input devices and/or output devices can be included in processing system 900, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 900 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 900.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method comprising:
converting user input natural language text into a machine readable task, wherein the machine readable task includes semantic understanding of the user input natural language text;
forming a plan from the machine readable task, wherein the plan includes tools and data applied to complete the plan;
forming a flow chart for chronologically representing the plan in a machine executable format;
executing a portion of the flow chart in a test environment;
verifying accuracy of the portion of the flow chart in the test environment, the accuracy including a metric for computer performance;
in response to the accuracy of the portion failing an accuracy test in the test environment, modifying the portion; and
performing the flow chart in a production environment.

2. The method of claim 1, further comprising:
generating a prompt to document a verified inaccurate portion in the test environment, the prompt including additional information that prevents failing the accuracy test for a same reason; and
incorporating the prompt into the flow chart.

3. The method of claim 1, further comprising:
refining the plan with constraints on the plan, the constraints including user defined limitations on the plan.

4. The method of claim 1, further comprising:
providing few-shot examples of successful plans to refine the plan.

5. The method of claim 1, further comprising:
invoking an external tool to perform at least one portion of the flow chart in the production environment, the external tool including Application Programming Interfaces (APIs).

6. The method of claim 1, further comprising:
invoking external private data while performing at least one portion of the plan in the production environment, the external private data being from a retrieval augmented generations (RAG) database.

7. The method of claim 1, wherein forming the flow chart identifies opportunity for parallel computing and generates parallel portions in the flow chart for execution in the production environment.

8. A system, comprising:
a processor; and
a memory storing computer-readable instructions that, when executed by the processor, cause the processor to:
convert user input natural language text into a machine readable task, wherein the machine readable task includes semantic understanding of the user input natural language text;
form a plan from the machine readable task, wherein the plan includes tools and data applied to complete the plan;
form a flow chart for chronologically representing the plan in a machine executable format;
execute a portion of the flow chart in a test environment;
verify accuracy of the portion of the flow chart in the test environment, the accuracy including a metric for computer performance;
in response to the accuracy of the portion failing an accuracy test in the test environment, modify the portion; and
perform the flow chart in a production environment.

9. The system of claim 8, wherein the memory further causes the processor to:
generate a prompt to document a verified inaccurate portion in the test environment, the prompt including additional information that prevents failing the accuracy test for a same reason; and
incorporate the prompt into the flow chart.

10. The system of claim 8, wherein the memory further causes the processor to:
refine the plan with constraints on the plan, the constraints including user defined limitations on the plan.

11. The system of claim 8, wherein the memory further causes the processor to:
providing few-shot examples of successful plans to refine the plan.

12. The system of claim 8, wherein the memory further causes the processor to:
invoke an external tool to perform at least one portion of the flow chart in the production environment, the external tool including Application Programming Interfaces (APIs).

13. The system of claim 8, wherein the memory further causes the processor to:
invoke external private data while performing at least one portion of the plan in the production environment, the external private data being from a retrieval augmented generations (RAG) database.

14. The system of claim 8, wherein the flow chart identifies opportunity for parallel computing and generates parallel portions in the flow chart for execution in the production environment.

15. A computer program product comprising a non-transitory computer-readable storage medium containing computer program code, the computer program code when executed by one or more processors causes the one or more processors to perform operations, the computer program code comprising instructions to:
convert user input natural language text into a machine readable task, wherein the machine readable task includes semantic understanding of the user input natural language text;
form a plan from the machine readable task, wherein the plan includes tools and data applied to complete the plan;
form a flow chart for chronologically representing the plan in a machine executable format;
execute a portion of the flow chart in a test environment;
verify accuracy of the portion of the flow chart in the test environment, the accuracy including a metric for computer performance;
in response to the accuracy of the portion failing an accuracy test in the test environment, modify the portion; and
perform the flow chart in a production environment.

16. The computer program product of claim 15, wherein the one or more processors:
generate a prompt to document a verified inaccurate portion in the test environment, the prompt including additional information that prevents failing the accuracy test for a same reason; and
incorporate the prompt into the flow chart.

17. The computer program product of claim 15, wherein the one or more processors:
refine the plan with constraints on the plan, the constraints including user defined limitations on the plan.

18. The computer program product of claim 15, wherein the one or more processors:
providing few-shot examples of successful plans to refine the plan.

19. The computer program product of claim 15, wherein the one or more processors:
invoke an external tool to perform at least one portion of the flow chart in the production environment, the external tool including Application Programming Interfaces (APIs).

20. The computer program product of claim 15, wherein the one or more processors:
invoke external private data while performing at least one portion of the plan in the production environment, the external private data being from a retrieval augmented generations (RAG) database.
